(19) United States
(12) Patent Application Publication
(10) Pub. No.: US 2006/0016995 A1
(43) Pub. Date: Jan. 26, 2006

(54) Microstructured infrared sensor and method for its manufacture

(76) Inventors: Nils Kummer, Ludwigsburg (DE); Roland Mueller-Fiedler, Leonberg (DE); Stefan Finkbeiner, Gomaringen (DE); Andre Mueller, Gerlingen (DE); Horst Muenzel, Reutlingen (DE); Dieter Maurer, Pfullingen (DE); Stefan Hiemer, Furth im Wald (DE); Jurgen Perthold, Kovb (DE)

Correspondence Address: KENYON & KENYON, ONE BROADWAY, NEW YORK, NY, 10004, US

(21) Appl. No.: 11/150,762

(22) Filed: Jun. 10, 2005

(30) Foreign Application Priority Data
Jun. 24, 2004 (DE) 10 2004 030 418.1

(51) Int. Cl. G01J 5/00

(52) U.S. Cl. 250/338.1

(57) ABSTRACT

A microstructured infrared sensor includes: a sensor chip having a diaphragm; a cavity formed underneath the diaphragm; a thermopile structure formed on the diaphragm and having bonded printed conductors; an absorber layer formed on the thermopile structure for absorbing infrared radiation; and a cap chip attached to the sensor chip. A sensor space is formed between the cap chip and the sensor chip, and the sensor space accommodates the thermopile structure. The infrared sensor also includes a convex lens area for focusing incident infrared radiation onto the absorber layer. The lens area may be formed on the top of the cap chip or on a lens chip attached to the cap chip. The lens area may be formed by drying a dispensed lacquer droplet, or by a softened, structured lacquer cylinder, or by subsequent etching of the dried lacquer droplet and the surrounding substrate material.

### FIELD OF THE INVENTION

The present invention relates to a microstructured infrared sensor and a method for its manufacture.

### BACKGROUND INFORMATION

Microstructured infrared sensors may be used, e.g., in gas detectors, in which IR (infrared) radiation emitted by a radiation source, an incandescent bulb operated in the low-current range, or an IR LED, for example, is transmitted over a measuring path and subsequently received by the infrared sensor, and the concentration of the gases to be detected in the measuring path is estimated from the absorption of the infrared radiation in specific wavelength ranges. Gas sensors of this type may be used, e.g., in automobiles, for example, for detecting a leak in an air conditioning unit operated using CO₂, or for checking the air quality of the ambient air.

In general, microstructured infrared sensors have a sensor chip as a substrate in which a diaphragm, underetched by a cavity, is formed. At least one thermopile structure, having two bonded printed conductors made of different conductive materials, e.g., polycrystalline silicon and a metal, and an absorber layer for absorbing the incident IR radiation is deposited on the diaphragm. The incident IR radiation is absorbed by the absorber layer, whereupon the latter is warmed according to the intensity of the absorbed radiation. The thermal voltage across the bonded printed conductors resulting from the temperature increase is read as a measuring signal. In general, a cap chip is attached in a vacuum-tight manner to the sensor chip, whereby a sensor space shielded from the exterior is formed for the thermopile structure. The sensor may be placed into a package provided with a cover having a screen for the passage of the IR radiation. The IR radiation to be detected thus strikes the absorber layer essentially vertically after passing through the screen of the cover and the silicon cap chip which is transparent to IR radiation. The screen has approximately the same diameter as the absorber layer beneath it.

To achieve sufficient sensitivity for detecting the gas concentration, a relatively large thermopile detector having a large number of thermopiles, i.e., printed conductors,,is generally formed. These may be run from the diaphragm to the surrounding substrate material in a cruciform shape.

Due to the large surface area needed and the complex design of the large thermopile structures, high costs are incurred in manufacturing the infrared sensor and the sensor module made up of the sensor, the package, and the cover.

An object of the present invention is to provide a method for manufacturing an infrared sensor such that a high sensitivity level is achieved for the sensor at a relatively low manufacturing cost.

### SUMMARY

In accordance with the present invention, the incident IR radiation is focused onto the absorber layer through a convergent, i.e., convex, lens. The convergent lens is formed on top of the sensor, i.e., on top of the cap chip or a lens chip additionally attached to the cap chip, so that no additional optical aids need to be mounted and adjusted.

Due to the increased sensitivity, the number of thermopiles, i.e., printed conductors, may be reduced. According to the present invention, the lateral dimensions of the diaphragm and of the absorber layer may also be reduced.

The present invention utilizes the fact that when the radiation is focused onto the absorber layer by a convergent lens, a measuring signal which is proportional to the radiation may be obtained. According to the present invention, the surface of the screen may be selected to be several times larger than the screens normally used. The convergent lens is formed by the convex lens area on top of the cap chip or of the additional lens chip and the bottom of the cap chip, which may be flat, i.e., as a convex-planar convergent lens in particular. Optical focusing may be achieved here due to the difference between the refractive indices of the air inside the package and of the semiconductor material of the cap chip or of the additional lens chip, and the difference between the refractive indices of the semiconductor material and of the vacuum of the sensor space.

According to the present invention, the number of thermopiles may be reduced to the point that they run only to one side of the diaphragm.

According to an example embodiment of the present invention, the convex lens area on the sensor surface may be formed as a dried lacquer layer. In this case, a liquid spherical cap of an optically transparent lacquer is formed on the surface; this lacquer forms a convex shape having the desired radiation-focusing effect due to the surface tension of the liquid and the wetting of the surface. A solid spherical cap may thus be formed as a convex lens area by subsequent drying.

The drop of lacquer may be formed by first applying a lacquer layer having a larger surface area and structuring a cylindrical area, which is then liquefied by inspissating a solvent.

Alternatively, a liquid lacquer droplet may be directly dispensed for this purpose, e.g., via a piston dispenser having a precision needle. Time and material are saved here compared to forming and structuring the lacquer layer and inspissating solvents. The advantages of using a piston dispenser are, e.g., that changes in pressure and viscosity have no effect on the dispensed volume. Furthermore, very small volumes may be metered, volumetric reproducibility is high (e.g., ±2%), low-viscosity materials do not reflow, and the material is not modified by shearing.

Compared to photolithography or special lithography, spin-on deposition and a prebake step of the first layer, spin-on deposition and prebake step of the second layer, edge lacquer removal, exposure, subsequent developing, and the required lacquer height control are no longer needed in the case of direct dispensing. The 10-minute dispensing step, for example, is also considerably shorter than the 45-minute swelling process required in special lithography, and the 2-hour drying, for example, according to the present invention is somewhat shorter than the 3-hour drying, for example, required for special lithography. The time for the overall process may thus be reduced by 60%, for example, and handling time by workers may be reduced by as much as over 80%.

Furthermore, smaller amounts of material are used in direct dispensing, because no excess material remains at the end of the process, in contrast to a process in which layers are applied and subsequently structured. Also, no developer, no solvent for swelling, and no photoresist are required, so that a considerable additional savings in materials may also be achieved.

Furthermore, in another example embodiment of the present invention, the convex lens area may also be formed in the substrate itself, i.e., in the cap chip or the additional lens chip. In this case, as in the above embodiments, a spherical cap of dried lacquer is first formed, and the spherical lacquer cap and the surrounding substrate material are then etched, e.g., dry etched. The shape of the lens formed in the substrate corresponds to the shape of the original spherical lacquer cap if the etching selectivity of the substrate material and the lacquer is selected to be 1:1; by varying the etching selectivity during the etching process, a non-spherical shape may also be achieved in the substrate, so that in principle complex geometries may also be formed.

### BRIEF DESCRIPTION OF THE DRAWINGS

FIG. 1 shows a cross-sectional view of an infrared sensor according to an example embodiment of the present invention.

FIG. 2 shows a top view of a sensor chip in the diaphragm area.

FIGS. 3a through 3c show the various steps of an example method for the manufacture of the cap chip of the sensor shown in FIG. 1.

FIGS. 4a through 4d show the various steps of another example method for the manufacture of a lens on the cap chip.

FIG. 5 shows a piston dispenser for carrying out the method shown in FIG. 4.

FIG. 6 shows a cross-sectional view of an infrared sensor according to another example embodiment of the present invention.

### DETAILED DESCRIPTION

As shown in FIG. 1, infrared sensor module 1 has a package 2 made of a molded compound or ceramic, for example, and a cover 3 attached to package 2 having a screen aperture 4. An infrared sensor 6 is placed in package inner space 5 formed between package 2 and cover 3. The infrared sensor 6 has a sensor chip 9 glued onto the bottom of package 2 and a cap chip 11 attached to sensor chip 9 by seal glass bond 10. Situated on the sensor chip 9, above a cavity 14 of the sensor chip 9, is a diaphragm 12. Diaphragm 12 and cavity 14 may be formed, for example, by forming or depositing an SiO₂ or Si₃N₄ layer on the substrate of sensor chip 9, structuring etched openings, etching cavity 14 underneath the layer, and subsequently sealing the etched openings.

Alternative to the embodiment shown in FIG. 1, a cavity 14 may be formed from the bottom of sensor chip 9 via KOH etching, for example, and the etching process may be stopped when a sufficiently thin diaphragm 12 has formed on the top or front of substrate 9. In this alternative embodiment, unlike that of FIG. 1, cavity 14 extends to the bottom of sensor chip 9.

Continuing with FIG. 1, at least one thermopile structure 17 having printed conductors 19 and 20, in contact with one another and made of different electrically conductive materials, e.g., polycrystalline silicon and aluminum or another metal, is deposited on diaphragm 12. The at least one thermopile structure 17 is formed such that the “warm contact area” of printed conductors 19 and 20 is located on diaphragm 12 and the “cold contact area” is located outside of diaphragm 12 on silicon substrate 9. An infrared absorber layer 21 is applied to the contact area of printed conductors 19, 20 on diaphragm 12 and is heated by the incident IR radiation, the temperature increase generating a thermal voltage across printed conductors 19, 20 which is measurable as an electrical signal.

A sensor space 23, in which a vacuum is insulated from the package inner space 5 by a seal glass bond areas 10, is formed between cap chip 11 and sensor chip 9. For this purpose, a cavity may be formed on the bottom of cap chip 11 via KOH etching, for example, this cavity forming sensor space 23 after cap chip 11 has been attached to sensor chip 9 in seal glass bond areas 10. An advantageously spherical convex lens area 24, e.g., made of silicon, is formed on top 22 of cap chip 11 in an area above thermopile structure 17. Convex silicon lens area 24 is formed in this embodiment in a depression 27 on top 22 and adjoins package inner space 5 which is filled with air, a protective gas, or vacuum, for example. Below the convex lens area 24, a flat boundary surface 25 adjoins sensor space 23 which is under vacuum. Thus, the combination of the convex lens area 24 and the flat boundary surface 25 acts as a convex-planar convergent lens 26, which focuses incident IR radiation from the outside through screen aperture 4 into package inner space 5 onto absorber layer 21. The focal point of the IR radiation is advantageously located in absorber layer 21 as a wide spot.

As an alternative example embodiment to the embodiment having a convex-planar convergent lens 24, a biconvex convergent lens or a convergent lens as a structure made up of a plurality of adjoining convex areas may also be formed. Furthermore, instead of the convergent lens, a prism-type structure having a tip pointing upward and obliquely descending planar surfaces may be formed as a beam-focusing device. In this case, it is relevant that the incident IR radiation is focused by the beam-focusing device onto absorber layer 21. The focal point or spot is advantageously located in absorber layer 12.

The surface area of screen aperture 4 is significantly larger than the surface area of absorber layer 21, e.g., 2 to 10 times larger, in the example embodiment shown in FIG. 1. Several times more IR radiation strikes convergent lens 26 in this way than without the use of such a beam-focusing device, the IR radiation being focused onto absorber layer 21. The heat introduced into absorber layer 21, which is increased proportionally to the incident light, results in a proportional increase in sensitivity, while the number of thermopile structures 17 remains the same.

If the same sensitivity of IR sensor 6 compared to an IR sensor designed without the use of a convergent lens 26 is desired, the number of thermopile structures 17 may be proportionally reduced, which reduces the dimensions of thermopile structures 17 and of sensor chip 9 accordingly.

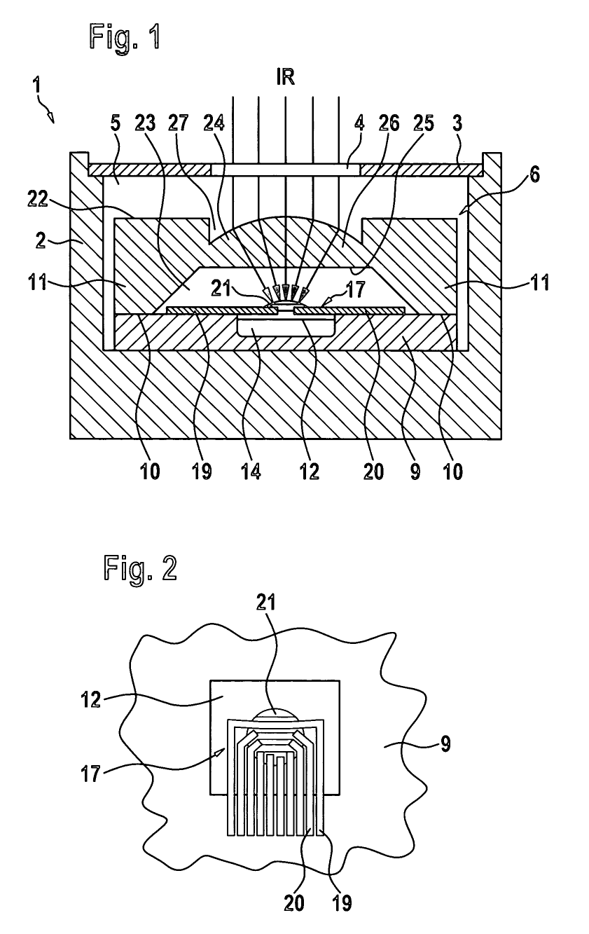

FIG. 2 shows a top view of diaphragm 12 having a plurality of thermopile structures 17, each having bonded printed conductors 19, 20. According to the present invention, they may be conducted away in a single direction, in FIG. 2 downward, instead of to all sides as in the currently customary cruciform embodiments.

In all embodiments shown, IR sensor 6 may be formed on the wafer level. For this purpose, a plurality of diaphragms 12, cavities 14, and thermopile structures 17 are formed in a sensor wafer, a plurality of convex lens areas 24 are formed on the top of a cap wafer, and cavities for sensor spaces 23 are formed on the bottom. Furthermore, seal glass, i.e., a low-melting lead glass, is applied to the sensor wafer around thermopile structures 17, and the cap wafer is placed in a bonding position onto the sensor wafer. By heating or baking the resulting wafer stack and subsequent singulation, individual IR sensors 6 may then be manufactured in a cost-effective manner.

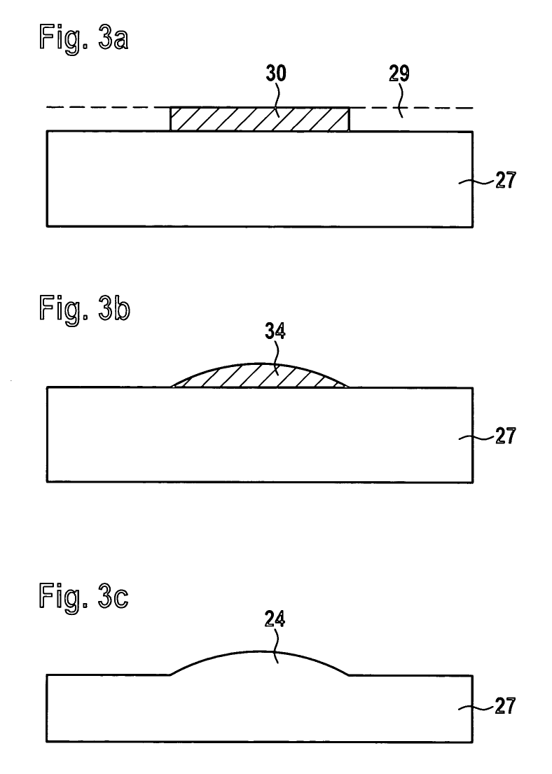

FIGS. 3a through 3c show the various steps of such a manufacturing process according to the present invention on the wafer level, i.e., prior to singulation. For this purpose, a minimally sensitive lacquer layer 29 is applied to the cap substrate, i.e., cap wafer 27, and structured photolithographically to form a cylinder 30, as shown in FIG. 3a. Subsequently, the lacquer of cylinder 30 is liquefied at a suitable temperature of 60° C. to 80° C., e.g., 75° C., while adding solvent vapor, e.g., acetone vapor, for 25 minutes. The liquefied lacquer forms, as shown in FIG. 3b, a liquid spherical cap 34 due to its wetting properties and the effect of gravity and surface tensions. The liquid spherical cap 34 is then rehardened, as shown in FIG. 3c, at a high temperature of 100° C. to 120° C., for example, to form a solid spherical cap 24. It is also possible to melt cylinder 30 by increasing the temperature to 150° C. to 160° C. without adding solvent vapor, and to then let the melted area harden. However, as a result of treatment with solvent vapor and subsequent hardening, changes in the lacquer during melting, in which solvent diffuses out and thus the lacquer changes its chemical consistency, are avoided. In particular, possible deviations from the desired target structure and resulting imaging errors due to the evaporation of the solvent, which may affect functioning of the optical system, are prevented or at least largely prevented.

In a dry etching system, the dried, solid spherical lacquer caps 34 and the surrounding silicon of cap wafer 27 are etched in such a way that the shape of the lacquer is transferred to the silicon of cap wafer 27 and convex lens area 24 is formed in cap wafer 27 as shown in FIG. 3c. If the silicon to lacquer etching selectivity is selected to be 1:1, the shape of convex lens area 24 in cap wafer 27 corresponds to the shape of the original spherical lacquer cap 34 as shown in FIG. 3b. However, by varying the etching selectivity during the etching process, a non-spherical shape may also be produced in the silicon of cap wafer 27.

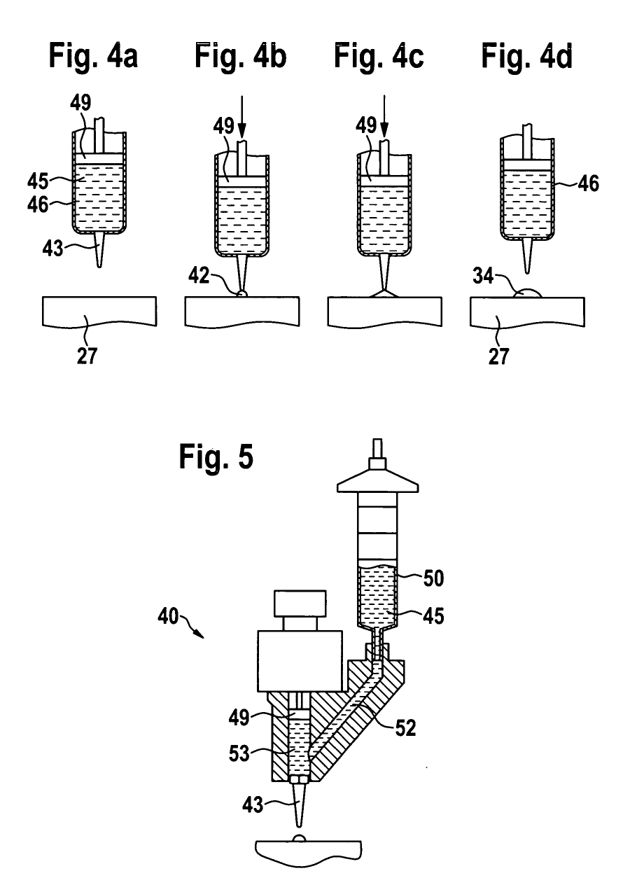

Alternative to the process shown in FIGS. 3a through 3c, spherical caps 34 of liquid lacquer may also be applied directly to cap wafer 27, as shown in FIGS. 4a through 4d. In this case, small droplets 42 of a lacquer liquid 45 or a liquid lacquer from a precision needle 43 are applied to cap wafer 27 using a piston dispenser 40, an example of which is shown in FIG. 5, and the droplets 42 subsequently form convex spherical caps 34 due to their surface tension. The relatively extensive, more time-consuming and more material-intensive photolithographic process of FIGS. 3a through 3c is replaced by this dispensing, i.e., metering procedure. The. above-mentioned changes in the lacquer during a melting process, e.g., possible deviations from the desired target structure and the resulting imaging errors, are largely or completely avoided in the method illustrated in FIGS. 4a through 4d.

FIGS. 4a through 4d schematically show a bottom portion of piston dispenser 40 in various steps of forming the spherical cap 34. As shown in FIG. 4a, cylinder 46 of the dispenser filled with lacquer liquid 45 is displaced toward cap wafer 27 until precision needle 43 is sufficiently close above the wafer. Subsequently a droplet 42 of lacquer liquid 45 is deposited on cap wafer 27 by a descending piston 49, as shown in FIG. 4b. The surface of cap wafer 27 may be wetted as soon as droplet 42 is formed on precision needle 43, as shown in FIG. 4c, so that even very small droplets may be formed. As shown in FIG. 4d, cylinder 46 is removed again vertically, so that initially liquid spherical cap 34 of liquid lacquer remains on cap wafer 27 and then hardens in this shape.

As shown in FIG. 5, piston dispenser 40 may have the following components. A cartridge, for example, may be used as container 50 for lacquer liquid 45, lacquer liquid 45 being conducted under a low pressure of 0.3 bar to 0.8 bar, for example, through a channel 52 to a pump chamber 53. When piston 49 moves upward, it produces a partial vacuum, causing lacquer liquid 45 to flow into the pump chamber 53. When the piston moves downward, the material supply is interrupted and piston 49 presses the desired amount of lacquer liquid 45 through the precision needle 43.

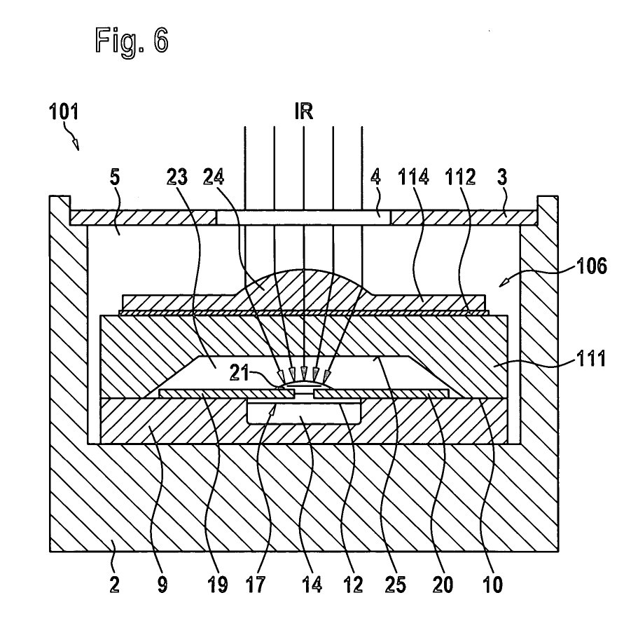

FIG. 6 shows another example embodiment of the sensor according to the present invention, having a package 2 and a cover 3 which are substantially identical to the first example embodiment of FIG. 1. Positioned within package 2 is IR sensor 106 having a sensor chip 9 with membrane 12. However, in the embodiment shown in FIG. 6, cap chip 111 has a flat top on which a silicon lens chip 114 is attached over an adhesive layer 112 made of an optically transparent adhesive. Lens chip 114 has convex lens area 24 on its top. Convex lens area 24 may be formed using any of the above-described processes, e.g., the example method shown in FIGS. 3a through 3c, or the example method shown in FIGS. 4a through 4d.

As an alternative example embodiment, sensor 106 may also be manufactured on the wafer level by manufacturing a sensor wafer, a cap wafer, and a lens wafer separately. In this embodiment, the cap wafer is to be structured only from one side to form sensor space 23, and the lens wafer is designed as cap wafer 27 shown in the first embodiment of FIG. 1. A wafer stack, in which the cap wafer is attached to the sensor wafer in seal glass bonding areas and the lens wafer is attached to the cap wafer by an adhesive layer, is subsequently produced from these three wafers. Alternative to the embodiment shown in FIG. 6, lens chip 114 may extend laterally to the width of cap chip 111 and sensor chip 6, so that the manufacture as a wafer stack and the subsequent singulation are easily facilitated.

What is claimed is:

1. A microstructured infrared sensor, comprising:
a sensor chip having a diaphragm and a cavity formed underneath the diaphragm;
at least one thermopile structure formed on the diaphragm and having at least two bonded printed conductors made of different, electrically conductive materials;
an absorber layer formed on the thermopile structure for absorbing infrared radiation;
a cap chip attached to the sensor chip in vacuum-tight bonding areas, wherein a sensor space under vacuum is formed between the cap chip and the sensor chip, and wherein the at least one thermopile structure is accommodated in the sensor space; and
a convex lens area for focusing incident infrared radiation onto the absorber layer, wherein the convex lens area is formed above the sensor space.

2. The infrared sensor as recited in claim 1, wherein the convex lens area is formed on the top of the cap chip.

3. The infrared sensor as recited in claim 2, wherein the convex lens area is located within a depression formed on the top of the cap chip.

4. The infrared sensor as recited in claim 1, wherein the convex lens area is formed on a lens chip attached to the top of the cap chip.

5. The infrared sensor as recited in claim 4, wherein the lens chip is attached to the cap chip by an adhesive layer made of an optically transparent adhesive.

6. The infrared sensor as recited in claim 3, wherein the convex lens area has an essentially spherical curvature.

7. The infrared sensor as recited in claim 5, wherein the convex lens area has an essentially spherical curvature.

8. The infrared sensor as recited in claim 3, wherein a convergent lens is formed by a combination of the convex lens area and a bottom area, and wherein the focal point of the convergent lens lies in the absorber layer.

9. The infrared sensor as recited in claim 2, wherein the convex lens area is formed as a cap of solidified lacquer, and wherein the convex lens area is transparent to infrared radiation.

10. The infrared sensor as recited in claim 9, wherein the transparent lacquer is a photoresist.

11. The infrared sensor as recited in claim 2, wherein the convex lens area is formed integrally with the cap chip.

12. The infrared sensor as recited in claim 4, wherein the convex lens area is formed integrally with the lens chip.

13. The infrared sensor as recited in claim 11, wherein a lateral dimension of the convex lens area is greater than a lateral dimension of the absorber layer.

14. The infrared sensor as recited in claim 12, wherein a lateral dimension of the convex lens area is greater than a lateral dimension of the absorber layer.

15. The infrared sensor as recited in claim 11, wherein the printed conductors of the thermopile structure are extended away to one side of the diaphragm.

16. The infrared sensor as recited in claim 12, wherein the printed conductors of the thermopile structure are extended away to one side of the diaphragm.

17. A sensor module, comprising:
a package housing;
a cover secured on the package housing and having an aperture for passage of infrared radiation, wherein a package inner space is formed between the package housing and the cover; and
an infrared sensor mounted in the package inner space, the infrared sensor including:
a sensor chip having a diaphragm and a cavity formed underneath the diaphragm;
at least one thermopile structure formed on the diaphragm and having at least two bonded printed conductors made of different, electrically conductive materials;
an absorber layer formed on the thermopile structure for absorbing infrared radiation;
a cap chip attached to the sensor chip in vacuum-tight bonding areas, wherein a sensor space under vacuum is formed between the cap chip and the sensor chip, and wherein the at least one thermopile structure is accommodated in the sensor space; and
a convex lens area for focusing incident infrared radiation onto the absorber layer, wherein the convex lens area is formed above the sensor space;
wherein the aperture of the cover is formed above the convex lens area of the infrared sensor.

18. A method for manufacturing an infrared sensor, comprising:
forming a sensor chip substrate having at least one diaphragm;
forming at least one thermopile structure on the diaphragm;
forming an absorber layer on top of the thermopile structure;
forming a liquid spherical cap from a lacquer that is transparent to infrared radiation, wherein the liquid spherical cap is formed on one of a cap substrate and a lens substrate;
solidifying the spherical cap to form a convex lens area; and
attaching the cap substrate to the sensor chip substrate, whereby the at least one thermopile structure is located in a sensor space formed between the cap substrate and the sensor chip substrate, and wherein the convex lens area is positioned above the absorber layer.

19. The method as recited in claim 18, wherein the liquid spherical cap is formed by depositing a droplet of a lacquer liquid using a precision dispensing needle.

20. The method as recited in claim 18, wherein the liquid spherical cap is generated by forming a lacquer layer of radiation-transparent lacquer, structuring a cylinder in the lacquer layer, and softening the cylinder by treatment with solvent vapor.

21. The method as recited in claim 19, wherein the liquid spherical cap is solidified by drying.

22. The method as recited in one of claim 21, wherein, after drying the liquid spherical cap, the convex lens area is formed by etching the dried spherical cap and surrounding portions of one of the cap substrate and the lens substrate such that the convex lens area is formed on one of the cap substrate and the lens substrate.

23. The method as recited in claim 22, wherein etching rates in the dried spherical cap and in the surrounding portions of one of the cap substrate and the lens substrate are approximately the same.

24. The method as recited in claim 22, wherein an etching rate in the dried spherical cap is different from an etching rate in the surrounding portions of one the cap substrate and the lens substrate, whereby a non-spherical convex lens area is formed on one of the cap substrate and the lens substrate.

25. The method as recited in claim 22, wherein the convex lens area is formed on the top of the cap substrate.

26. The method as recited in claim 18, wherein the convex lens area is formed on the lens substrate, and wherein the lens substrate is attached to the top of the cap chip by a radiation-transparent adhesive layer.

27. The method as recited in claim 18, wherein the convex lens area is positioned such that a focal point of the convex lens area is in the absorber layer.

28. The method as recited in claim 26, wherein the convex lens area is positioned such that a focal point of the convex lens area is in the absorber layer.
